(19) United States
(12) Patent Application Publication
(10) Pub. No.: US 2022/0034386 A1
(43) Pub. Date: Feb. 3, 2022

(54) DRIVE CHAIN TENSIONER ASSEMBLY

(71) Applicant: Richard Mellick Zock, Lapeer, MI (US)

(72) Inventor: Richard Mellick Zock, Lapeer, MI (US)

(21) Appl. No.: 17/304,899

(22) Filed: Jun. 28, 2021

Related U.S. Application Data
(60) Provisional application No. 62/706,088, filed on Jul. 31, 2020.

(51) Int. Cl. F16H 7/08; F16H 7/06

(52) U.S. Cl. CPC F16H 7/08; F16H 7/06; F16H 2007/0895; F16H 2007/0842; F16H 2007/087; F16H 2007/0808

(57) ABSTRACT

A drive chain tensioner assembly for all-terrain and utility vehicles, wherein the drive chain tensioner provides a tension spring between the axis of rotation and a distal portion of a mounting bracket, wherein the mounting bracket and tension spring are coplanar. The proximal portion of the mounting bracket is rotatably connected about a second pivot point spaced apart from a first pivot point associated with the axis of rotation by way of a tension arm. A bracket head may interconnect the second pivot point and the mounting bracket. The tension spring and second pivot point affords the present invention with functional self-adjustability as a result of the foregoing.

### CROSS-REFERENCE TO RELATED APPLICATION

This application claims the benefit of priority of U.S. provisional application No. 62/706,088, filed 31 Jul. 2020, the contents of which are herein incorporated by reference.

### BACKGROUND OF THE INVENTION

The present invention relates to drive chains and, more particularly, a drive chain tensioner assembly for utility vehicles, such as but not limited to all-terrain vehicles (ATV), 4-wheelers, quadricycles, go-karts, and the like.

The drive chain on a machine can loosen while being ridden in a cruise speed, under high speed or somewhere there between. The drive chain will stretch if not adjusted properly, and as a result “jump” off the sprocket, causing bigger and more expensive problems. Moreover, the looser the drive chain the further acceleration is diminished for the vehicle.

Other drive chain tensioners are supposedly “universal”, through afford only a one-time use for specific model of utility vehicles because of the space they need to occupy. Current drive chain tensioners use torsion spring functionality and relying on material that cannot withstand the abuse a chain tensioner of an ATV is reasonably expected to endure.

As can be seen, there is a need for a drive chain tensioner assembly for utility vehicles, wherein the drive chain tensioner assembly is made from high grade metal and employs a heavy-duty tension spring and toothed gear functionality, thereby providing the assembly with sufficient tension on the drive chain for keeping the chain sufficiently taut.

Furthermore, the drive chain tensioner assembly embodied by the present invention utilizes pinpointed mounting holes, making the assembly serviceable and useable for different vehicles.

### SUMMARY OF THE INVENTION

In one aspect of the present invention, a drive chain tensioner assembly, the assembly includes a tension spring coplanar with a mounting bracket, wherein the tension spring extends between a first pivot point of a sprocket of a drive chain and a distal portion of the mounting bracket, and wherein a proximal portion of the mounting bracket engages a second pivot point.

In another aspect of the present invention, the drive chain tensioner assembly further includes at least one spring pin connected to the distal portion, wherein the spring pin engages the tension spring; a plurality of mount openings along said distal portion, wherein each mount opening is dimensioned to removably connect with the at least one spring pin; a tension arm extending between the first pivot point and the second pivot point; a bracket head interconnecting the second pivot point and fixedly connected to said proximal portion; wherein the first and second pivot points are horizontally offset by approximately a radius of the sprocket; a plurality of sprocket teeth radially extending from the sprocket; a drive chain operatively associated with the one or more plurality of sprocket teeth, wherein a pivot pin defines each of the first and second pivot points, wherein a pivot pin defines each of the first and second pivot points, wherein the second pivot point is fixedly connected by the pivot pin.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a side view of an exemplary embodiment of the present invention;

FIG. 3 is an exploded perspective view of an exemplary embodiment of the present invention;

FIG. 4 is a section view of an exemplary embodiment of the present invention, taken along line 4-4 in FIG. 1;

FIG. 5 is a section view of an exemplary embodiment of the present invention, taken along line 5-5 in FIG. 1; and

FIG. 6 is a section view of an exemplary embodiment of the present invention with the drive chain 28 removed and the tension released.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, the present invention provides a drive chain tension assembly for all-terrain and utility vehicles, wherein the drive chain tensioner assembly is adapted to self-adjust in such a way as to provide sufficient tension on the drive chain for keeping the drive chain taut throughout a range of actions, including between cruise speed and under high speed.

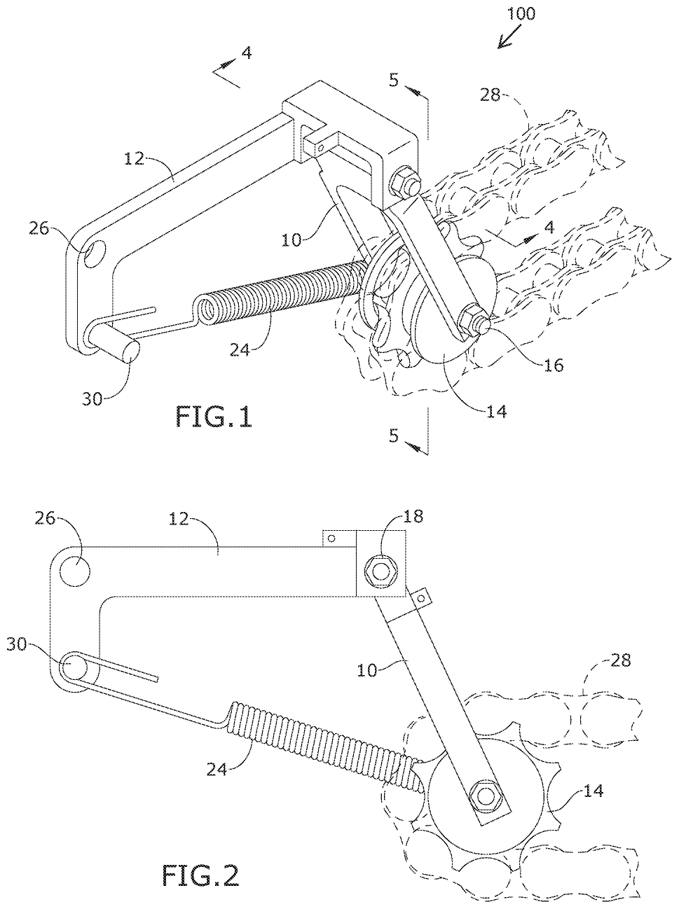

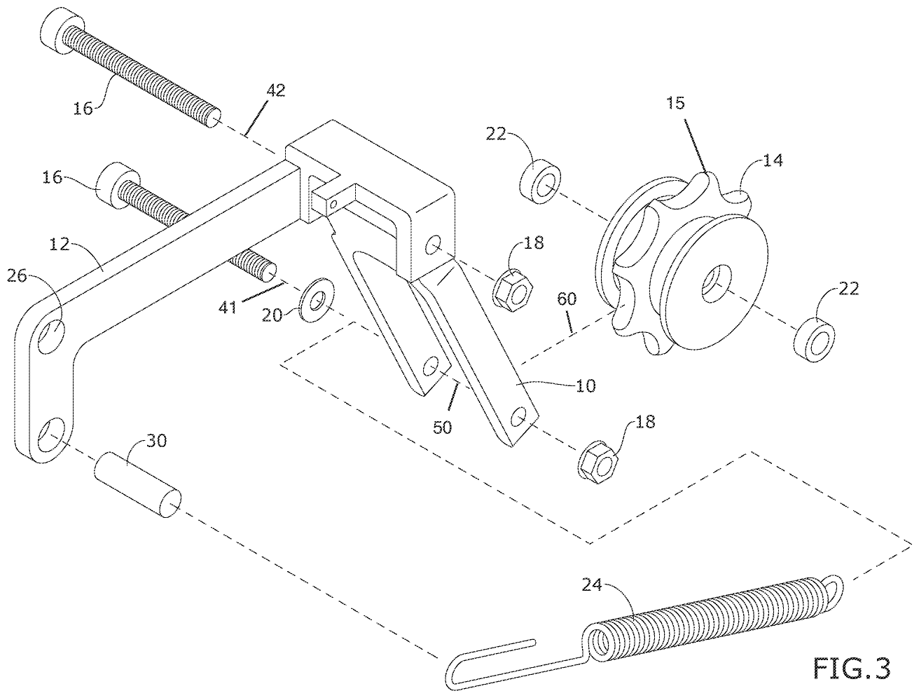

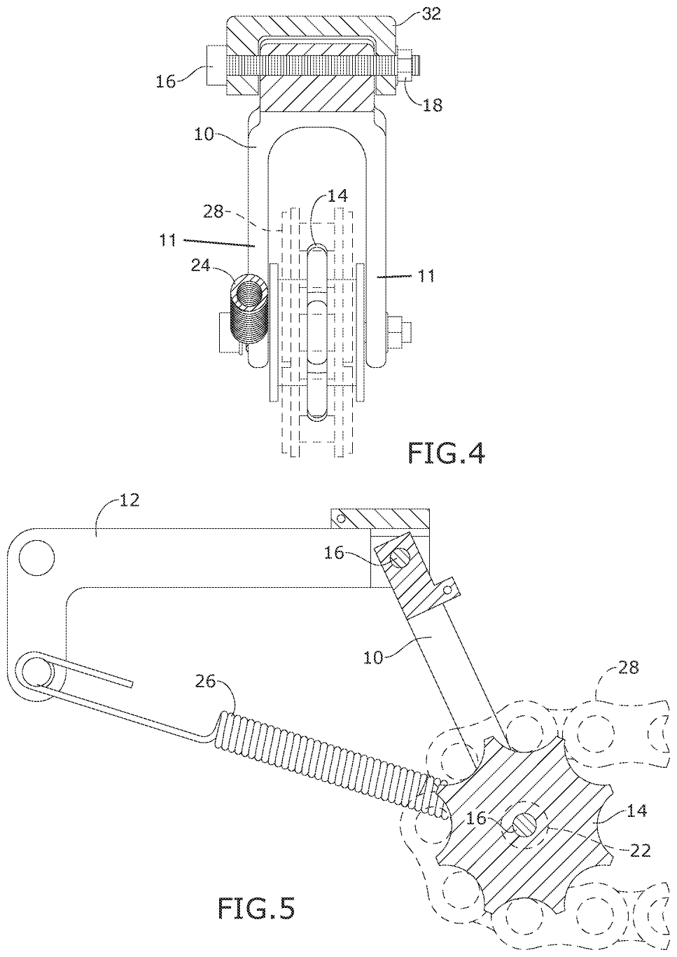

Referring now to FIGS. 1 through 6, the present invention may include a drive chain tensioner assembly 100 having a tension arm 10 supporting an axis of rotation 50 about a first pivot point 41 of the chain sprocket 14 of the drive chain 28, wherein a tension spring 24 self-adjusts the tension on the chain sprocket 14 through axially loading the axis of rotation 50 by way of an adjustable spring pin 30. The tension arm 10 extends between and supports the first pivot point 41 and a second pivot point 42.

The teeth 15 of the chain sprocket 14 operatively associate with the drive chain 28. At the first pivot point 41, a pivot pin 16 may define the first axis of rotation 50 of the chain sprocket 14, which in turn may be supported by one of more bearings 22 (such as a sleeve bearing) and fasteners (spacers, washers, nuts, bolt, etc.) 18, 20 between the fork 11 of the tension arm 10. The one of more bearings 22 may be adapted to fit on the tension arm 10 so that a shim slides onto each bearing 22, which is all held together with the appropriate fasteners 18, 20. Thereby, the chain sprocket 14 may be adapted to operatively associated with the tension arm 10. The spacer may be slid and secured in place by, in certain embodiments, a clip.

The tension spring 24 may join the pivot pint 16 of the first pivot point 41 to a spring pin 30 of a mounting bracket 12, while the mounting bracket 12 rotatably connects about the second pivot point 42 also defined in part by a pivot pin 16. The second pivot point 42 may be disposed outside of the vertical profile of the chain sprocket 14 in order not to interfere with the drive chain 28. In other words, the first and second pivot points 41 and 42 are not aligned on a point along a horizontal axis 60, but rather are horizontally offset (as well as vertically offset).

The mounting bracket 12 may provide one or more mounting openings 26 along its distal portion 13 for selectively placing the spring pin 30, thereby facilitating a truly universal solution to slack developing in the drive chain 28 of a wide variety of utility vehicles. Torsion springs are not as linear as tension springs, which deflect along their length, and as a result a torsion spring would occupy a wider space than the present invention, which is essentially substantially normal to the axis of rotation 50 along a singular plane shared by the mounting bracket 12 and the tension spring 26.

A bracket head 32 may be connected to a proximal end of the mounting bracket 12. The bracket head 32 may be U-shaped so that it can engage and support the pivot pin 16 of the second pivot point 42 at spaced apart points generally aligned with the forks 11 of the tension arm 10, further cooperating with the tension arm 10. The mounting bracket 12 extends from one side or the other of the bracket head 32 thereby facilitating the coplanar orientation of the mounting bracket 12 and the tension spring 24, which in turn makes the present invention more universal as the space needed for installation of the present invention is constrained mostly only by this linearity.

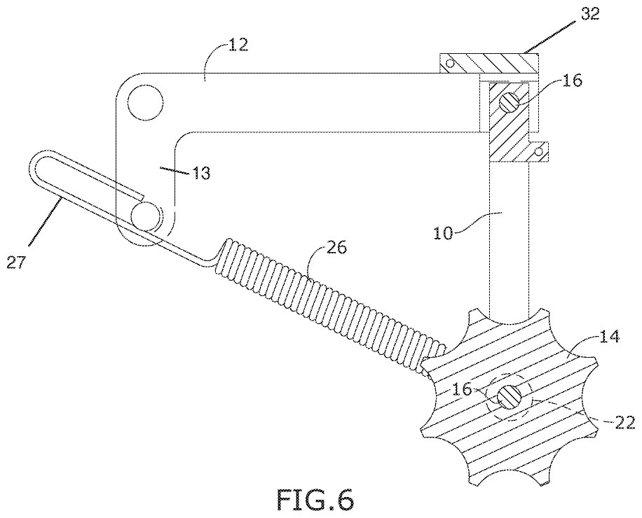

The distal end 27 of the tension spring 24 engages the spring pin 30. The distal end 27 may be a removably attachable connector, including but not limited to a hook portion (even though that is shown in the Figures). As a result, the distal end 27 may be disengaged from the spring pin 30/mounting bracket 12 to remove the tension from the drive chain 28, as illustrated in FIG. 6. Then the pivot pin 30 may be moved to another mount opening 26 and the distal end 27 re-engaged for an adjusted gradient of exerted force on the first pivot point 41. It should be noted that even though only two mount openings 26 are illustrated, there could be far more. It also being understood that there may be multiple pivot pins 30 disposed along the distal portion of the mounting bracket 12, and thus no need to remove and move the spring pin 30. It is further understood that the spring pin 30 and distal end 27 of the tension spring 24 may be any ways or structure for removably attaching one object to another object.

To be clear, the present invention is also self-adjusting in that the tension spring 24 is not in a position of rest when in use and so exerting an axial force along its length, wherein the exerted force increases and decreases proportional to changes in deflection of the tension spring 24 length resulting from slacking of the drive chain 28, for instance. Furthermore, the second pivot point 42 enables self-adjustments in directions transverse to the axial line of force of the tension spring 24.

A method of using the present invention may include the following. The drive chain tensioner assembly 100 disclosed herein may be provided. By installing the drive chain tensioner assembly 10, using the mounting hardware provided to mount the drive chain tensioner assembly 10 to a structural component of the vehicle (not shown), the present invention would self-adjust the tension of the drive chain 28 depending on the riding situation. In certain embodiment, there would be no need to remove or replace other components to install the present invention on a pre-exiting utility vehicle/ATV.

It should be understood, of course, that the foregoing relates to exemplary embodiments of the invention and that modifications may be made without departing from the spirit and scope of the invention as set forth in the following claims.

What is claimed is:

1. A drive chain tensioner assembly, the assembly comprising:
a tension spring coplanar with a mounting bracket, wherein the tension spring extends between a first pivot point of a sprocket of a drive chain and a distal portion of the mounting bracket, and wherein a proximal portion of the mounting bracket engages a second pivot point.

2. The assembly of claim 1, further comprising at least one spring pin connected to the distal portion, wherein the spring pin engages the tension spring.

3. The assembly of claim 2, further comprising a plurality of mount openings along said distal portion, wherein each mount opening is dimensioned to removably connect with the at least one spring pin.

4. The assembly of claim 3, further comprising a tension arm extending between the first pivot point and the second pivot point.

5. The assembly of claim 4, further comprising a bracket head interconnecting the second pivot point and fixedly connected to said proximal portion.

6. The assembly of claim 5, wherein the first and second pivot points are horizontally offset by approximately a radius of the sprocket.

7. The assembly of claim 6, further comprising a plurality of sprocket teeth radially extending from the sprocket.

8. The assembly of claim 7, further comprising a drive chain operatively associated with the one or more plurality of sprocket teeth.

9. The assembly of claim 8, wherein a pivot pin defines each of the first and second pivot points.

10. The assembly of claim 9, wherein a pivot pin defines each of the first and second pivot points.

11. The assembly of claim 10, wherein the second pivot point is fixedly connected by the pivot pin.
